(19) United States
(12) Patent Application Publication
(10) Pub. No.: US 2016/0001334 A1
(43) Pub. Date: Jan. 7, 2016

(54) SUBSTRATE CLEANING METHOD AND SUBSTRATE CLEANING APPARATUS

(71) Applicant: Tokyo Electron Limited, Tokyo (JP)

(72) Inventor: Kazuya DOBASHI, Nirasaki (JP)

(21) Appl. No.: 14/789,630

(22) Filed: Jul. 1, 2015

(30) Foreign Application Priority Data
Jul. 2, 2014 (JP) 2014-136643
Mar. 30, 2015 (JP) 2015-068113

(51) Int. Cl. B08B 6/00; B08B 5/00

(52) U.S. Cl. CPC B08B 6/00; B08B 5/00

(57) ABSTRACT

In a substrate cleaning method for cleaning a substrate, the substrate is arranged in a process chamber and exhausting an interior of the process chamber to keep the interior of the process chamber at a vacuum state, and a gas cluster including an electrically charged gas cluster is irradiated toward the substrate in the process chamber. Then, the electrically charged gas cluster is accelerated before the electrically charged gas cluster reaches the substrate, and particles on the substrate are removed by collision of the gas cluster including the accelerated electrically charged gas cluster with the substrate. The substrate and the particles which are electrically charged after the collision are neutralized, and the removed and neutralized particles are discharging from the process chamber along with an exhaust flow.

### CROSS-REFERENCE TO RELATED APPLICATIONS

This application claims priority to Japanese Patent Application Nos. 2014-136643 and 2015-068113 respectively filed on Jul. 2, 2014 and Mar. 30, 2015, the entire contents of which are incorporated herein by reference.

### FIELD OF THE INVENTION

The present invention relates to a substrate cleaning method and a substrate cleaning apparatus that use a gas cluster.

### BACKGROUND OF THE INVENTION

In a manufacturing process of a semiconductor device, since particles adhered to a substrate lead to a defect in a product, a cleaning process is performed to remove the particles adhered to the substrate. As for such a substrate cleaning technique, a technique in which gas clusters are irradiated to a surface of the substrate to remove particles on the surface of the substrate by a physical action of the gas clusters is attracting attention.

As a cleaning method for cleaning the substrate surface by using a gas cluster, there is known a method in which a cluster-generating gas such as CO₂ is jetted at a high pressure from a nozzle and adiabatically expands to generate a gas cluster, the generated gas cluster ionizes by an ionization unit, and a gas cluster ion beam formed by accelerating the ionized gas cluster by an accelerating electrode is irradiated to the substrate (see, e.g., Japanese Patent Application Publication No. 1992-354865).

Although having no relation to the substrate cleaning, there is known a technique in which a neutral gas cluster generated by adiabatic expansion is irradiated to the substrate (see, e.g., PCT Patent Publication No. WO 2010/021265). Currently, a method of reducing an electric damage to the substrate by applying the above technique to the substrate cleaning process is being studied.

However, in both of a case where the substrate cleaning is performed by using the gas cluster ion beam as disclosed in Japanese Patent Application Publication No. 1992-354865 and a case where the substrate cleaning is performed by using the neutral gas cluster beam as disclosed in PCT Patent Publication No. WO 2010/021265, when particles are removed by the gas cluster beam, the substrate and the particles are electrically charged due to a friction therebetween. Accordingly, it has been found that there is a possibility of readherence of the particles onto the substrate.

Further, in a case of physically removing the particles by using the neutral gas cluster beam as disclosed in PCT Patent Publication No. WO 2010/021265, the gas cluster is not accelerated. Therefore, a physical action is not sufficiently generated and thus there arises a concern that the cleaning may not be sufficiently performed. The physical power can be improved by increasing a cluster size. In this case, however, it is difficult to effectively improve a removal rate of the particles that are smaller than the cluster size. Moreover, in this case, a possibility of giving damage to a fine structure (pattern) on the substrate is increased.

### SUMMARY OF THE INVENTION

In view of the above, the present invention provides a substrate cleaning method and a substrate cleaning apparatus which are capable of removing particles adhered to a substrate at a high removal rate by using a gas cluster while suppressing readherence of the particles onto the substrate.

In accordance with an aspect of the present invention, there is provided a substrate cleaning method for cleaning a substrate, the substrate cleaning method including: arranging the substrate in a process chamber and exhausting an interior of the process chamber to keep the interior of the process chamber at a vacuum state; irradiating a gas cluster including an electrically charged gas cluster toward the substrate in the process chamber; accelerating the electrically charged gas cluster before the electrically charged gas cluster reaches the substrate; removing particles on the substrate by collision of the gas cluster including the accelerated electrically charged gas cluster with the substrate; neutralizing the substrate and the particles which are electrically charged after said collision; and discharging, from the process chamber, the removed and neutralized particles along with an exhaust flow.

In accordance with another aspect of the present invention, there is provided a substrate cleaning apparatus for cleaning a substrate by using a gas cluster, the substrate cleaning apparatus including: a process chamber configured to accommodate the substrate therein; an exhaust mechanism configured to exhaust an interior of the process chamber to be maintained in a vacuum state; an irradiation unit configured to irradiate a gas cluster including an electrically charged gas cluster toward the substrate in the process chamber; an acceleration unit configured to accelerate the electrically charged gas cluster before the electrically charged gas cluster reaches the substrate; and a charge-eliminating unit configured to neutralize the substrate and particles on the substrate which are electrically charged after the particles on the substrate are removed by the gas cluster including the accelerated electrically charged gas cluster, wherein the particles removed from the substrate and neutralized by the charge-eliminating unit are discharged along with an exhaust flow from the process chamber by the exhaust mechanism.

### BRIEF DESCRIPTION OF THE DRAWINGS

The objects and features of the present invention will become apparent from the following description of embodiments, given in conjunction with the accompanying drawings, in which:

FIG. 1 is a cross-sectional view showing a substrate cleaning apparatus in accordance with a first embodiment of the present invention;

FIGS. 2A to 2D are views for explaining a process operation of the substrate cleaning apparatus in accordance with the first embodiment;

FIG. 3 is a cross-sectional view showing a substrate cleaning apparatus in accordance with a second embodiment of the present invention;

FIG. 4 is a cross-sectional view showing a substrate cleaning apparatus in accordance with a third embodiment of the present invention;

FIG. 5 is a cross-sectional view showing a substrate cleaning apparatus in accordance with a fourth embodiment of the present invention;

FIG. 6 is a view showing a relationship between a mixing ratio of He gas and a velocity of a gas cluster (a relative value when a velocity of a gas cluster generated by supplying only CO₂ gas is assumed to be 1);

FIG. 7 is a schematic view showing a measurement system used in a test of verifying generation of an electrically charged gas cluster;

FIG. 8 is a view showing ion current measured by the measurement system of FIG. 7 when changing a gas supply pressure with respect to a case of supplying only CO₂ gas, a case of supplying CO₂ gas mixed with He gas (CO₂:He=1:1 and CO₂:He=1:9), and a case of supplying only He gas;

FIG. 9 is a cross-sectional view showing a substrate cleaning apparatus in accordance with a fifth embodiment of the present invention;

FIG. 10 is a view for explaining a model of a primary theoretical formula of a gas velocity;

FIG. 11 is a cross-sectional view showing a substrate cleaning apparatus in accordance with a sixth embodiment of the present invention;

FIG. 12 is a view showing another example of an accelerating unit for accelerating an electrically charged gas cluster; and

FIG. 13 is a view showing still another example of the accelerating unit for accelerating the electrically charged gas cluster;

### DETAILED DESCRIPTION OF THE EMBODIMENTS

Hereinafter, embodiments of the present invention will be described in detail with respect to the accompanying drawings.

### First Embodiment

First, description will be made on the first embodiment.

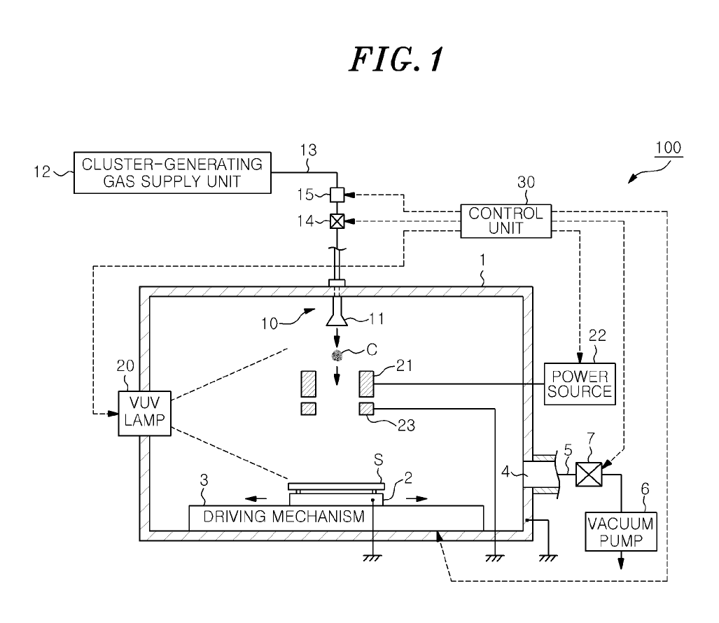

FIG. 1 is a cross-sectional view showing a substrate cleaning apparatus in accordance with the first embodiment of the present invention.

A substrate cleaning apparatus 100 performs a substrate cleaning process by removing particles adhered to the substrate by using a gas cluster.

The substrate cleaning apparatus 100 includes a process chamber 1 which defines a processing space for performing a cleaning process. A substrate mounting table 2 on which a substrate S to be processed is mounted is arranged in the process chamber 1. Various substrates such as a semiconductor wafer, a glass substrate for flat panel display and the like may be used as the substrate S, and the substrate S is not particularly limited as long as the attached particles are required to be removed. The substrate mounting table 2 is driven by a driving mechanism 3.

An exhaust port 4 is arranged at the lower portion of the sidewall of the process chamber 1 and is connected to an exhaust line 5. A vacuum pump 6 is provided at the exhaust line 5. The interior of the process chamber 1 is vacuum-exhausted by the vacuum pump 6. At this time, the vacuum level can be controlled by a pressure control valve 7 provided at the exhaust line 5. These components constitute an exhaust mechanism by which the interior of the process chamber 1 is maintained at a predetermined vacuum level.

Above the substrate mounting table 2, a gas cluster irradiation mechanism 10 which irradiates to the substrate S a gas cluster for cleaning is arranged. The gas cluster irradiation mechanism 10 includes: a cluster nozzle 11 provided at the upper portion of the process chamber 1 so as to face the substrate mounting table 2; a cluster-generating gas supply unit 12 provided at the outside of the process chamber 1 so as to supply a gas for generating a cluster to the cluster nozzle 11; and a gas supply line 13 through which the gas from the cluster-generating gas supply unit 12 is guided to the cluster nozzle 11. An opening/closing valve 14 and a flow rate controller 15 are provided at the gas supply line 13. The cluster nozzle 11 has a substantially conical shape that gradually widens toward the leading end but the shape is not limited thereto.

When a cluster-generating gas is supplied from the cluster-generating gas supply unit 12, the supply pressure increases by a pressure increasing device (gas booster) (not shown), and becomes a high pressure of, e.g., 5 MPa or less. A pressure gauge (not shown) is further provided at the gas supply line 13. The supply pressure is controlled based on a pressure value measured by the pressure gauge. If the cluster-generating gas from the cluster nozzle 11 is jetted into the process chamber 1 that is kept in a vacuum state, the cluster-generating gas adiabatically expands and some atoms or molecules of the gas, e.g., several to about 10⁷ atoms or molecules of the gas cohere by van der Waales force, thereby generating a gas cluster.

The cluster-generating gas is not particularly limited, but may be Co₂ gas, Ar gas, N₂ gas, SF₆ gas, CF₄ gas or the like. These gases may be used as a single gas or a mixture gas.

In order to jet the generated gas cluster to the substrate S without breaking, it is preferable that a pressure in the process chamber 1 is low. For example, it is preferable that the pressure in the process chamber 1 is 10 Pa or less when the supply pressure of a gas supplied to the cluster nozzle 11 is equal to or less than 1 MPa, and the pressure in the process chamber 1 is 300 Pa or less when the supply pressure is between 1 MPa and 5 MPa.

A VUV (vacuum ultraviolet) lamp 20 which radiates VUV into the process chamber 1 is provided at one side of the sidewall of the process chamber 1. By the energy of the VUV radiated from the VUV lamp 20, a gas in an irradiated region is ionized. Accordingly, by irradiating the VUV to a gas cluster C jetted from the cluster nozzle 11, at least a part of the gas cluster C is electrically charged into minus or plus to become charged particles.

The gas cluster C jetted from the cluster nozzle 11 collides with the substrate S so that particles adhered on the substrate S are removed. At this time, the substrate S and the particles are electrically charged due to a friction between the substrate S and the particles, and therefore, the particles may be adhered again onto the substrate S. However, the VUV from the VUV lamp 20 is irradiated to atmosphere around the substrate S to generate ions. Then, the electrically charged substrate S and particles are neutralized by the generated ions, so that the readherence of the particles is suppressed.

The VUV lamp 20 functions as a charging unit (ionization unit) that electrically charges the gas cluster C, and as a charge-eliminating unit that neutralizes the substrate S, the particles removed from the substrate S, and the charged cluster. Further, such charging unit and charge-eliminating unit are not limited to the VUV lamp, but may use electromagnetic wave of a wavelength having energy capable of ionizing a gas. Therefore, electromagnetic wave having a wavelength of 300 nm or below such as an X-ray, a gamma ray, a part of ultraviolet, and the like may be very preferably used.

Between the cluster nozzle 11 and the substrate S on the substrate mounting table 2, an accelerating electrode 21 is provided as an accelerating unit for accelerating the gas cluster C electrically charged by the VUV irradiation. A voltage from a power source 22 is applied to the accelerating electrode 21. Here, it is preferable that the voltage is about between 0.1 kV and 20 kV.

A ground electrode 23 which is grounded is provided below the accelerating electrode 21. The process chamber 1 and the substrate mounting table 2 are also grounded. Due to their grounding, the effect of electrostatic force on the particles can be decreased.

The driving mechanism 3 moves the substrate mounting table 2 on one plane such that the gas cluster C jetted from the cluster nozzle 11 is irradiated to the entire surface of the substrate S. For example, the driving mechanism 3 includes an XY table. Instead of moving on a plane the substrate S through the substrate mounting table 2 by the driving mechanism 3, the cluster nozzle 11 may be moved on a plane or each of the substrate mounting table 2 and the cluster nozzle 11 may be moved on a plane. Otherwise, the substrate mounting table 2 may be rotated and the cluster nozzle 11 may be moved.

A loading/unloading port (not shown) through which the substrate S is loaded and unloaded is provided at the sidewall of the process chamber 1. The process chamber 1 is connected to a vacuum transfer chamber (not shown) through the loading/unloading port. The loading/unloading port can be opened and closed by a gate valve (not shown). The substrate S is loaded and unloaded into and from the process chamber 1 by a substrate transfer device in the vacuum transfer chamber.

The substrate cleaning apparatus 100 includes a control unit 30. The control unit 30 includes a controller having a microprocessor (computer) which controls gas supply (the opening/closing valve 14 and the flow rate controller 15) and gas exhaust (the pressure control valve 7) of the substrate cleaning apparatus 100, the driving of the substrate mounting table 2 by the driving mechanism 3, the VUV irradiation from the VUV lamp 20, a voltage of the power source 22, and the like. A keyboard through which an operator performs an input operation of a command and the like to manage the substrate cleaning apparatus 100, a display on which operation state of the substrate cleaning apparatus 100 is visually displayed, and the like are connected to the controller. Also connected to the controller is a storage unit which stores: process recipes that are a control program for implementing the process in the substrate cleaning apparatus 100 under the control of the controller and a control program for executing a predetermined process with respect to the respective components of the substrate cleaning apparatus 100 according to a process condition; various databases and the like. The recipes are stored in a proper storage medium in the storage unit. Any one of the recipes is called from the storage unit and executed by the controller as occasion demands. Accordingly, a desired process in the substrate cleaning apparatus 100 is performed under the control of the controller.

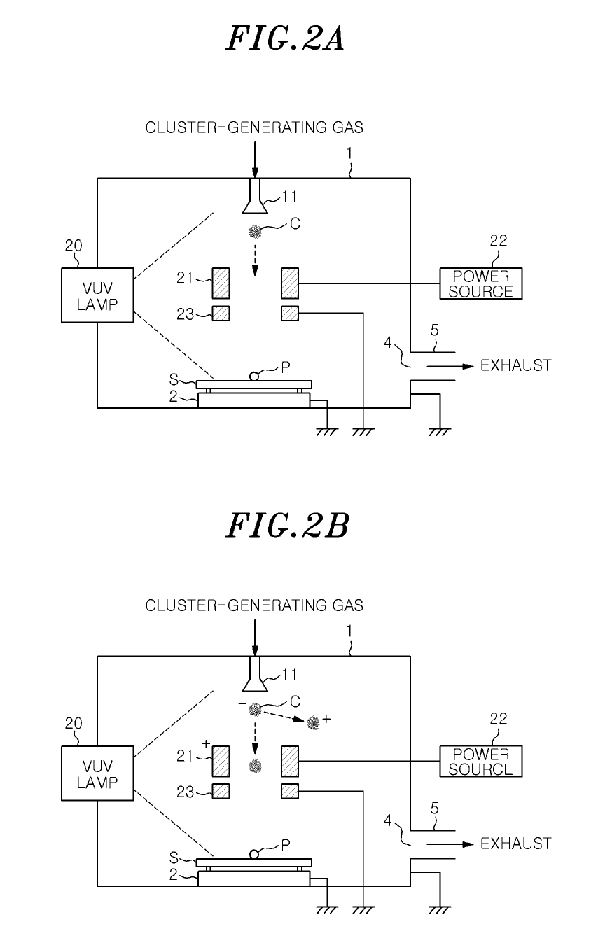

Next, an operation of the aforementioned substrate cleaning apparatus 100 will be described with reference to FIGS. 2A to 2D.

First, the gate valve is opened to load the substrate S through the loading/unloading port. The substrate S is mounted on the substrate mounting table 2. The interior of the process chamber 1 is vacuum-exhausted by the vacuum pump 6 to be kept at a vacuum state of a predetermined pressure. The pressure of the cluster-generating gas such as CO₂ gas from the cluster-generating gas supply unit 12 is increased by the pressure increasing device (gas booster) at a predetermined flow rate, and the cluster-generating gas is jetted at a predetermined supply pressure from the cluster nozzle 11. The cluster-generating gas jetted from the cluster nozzle 11 is adiabatically expanded to generate an almost neutral gas cluster C (see FIG. 2A). Alternatively, the supply pressure may be adjusted by only a flow rate of the cluster-generating gas without using the pressure increasing device.

The VUV radiated from the VUV lamp 20 is irradiated to the gas cluster C jetted from the cluster nozzle 11. Then, at least a part of the gas cluster C is electrically charged into minus or plus. By the supply of, e.g., positive charge to the accelerating electrode 21, the minus charged gas cluster C is attracted and accelerated by the accelerating electrode 21. On the other hand, the plus charged gas cluster C is repelled by the accelerating electrode 21 to move to the outside of the accelerating electrode 21 and exhausted (see FIG. 2B). The gas cluster C including the charged gas cluster attracted and accelerated by the accelerating electrode 21 becomes to possess increased energy and thus a cleaning power is increased.

At this time, the amount of the gas cluster C irradiated to the substrate S decreases as much as the amount of the plus charged gas cluster C. Therefore, it is preferable that the amount of the gas cluster C jetted from the cluster nozzle 11 is adjusted such that the amount of the gas cluster C reaching the substrate S becomes enough to clean the substrate S.

The charged gas cluster among the gas cluster C passing through the accelerating electrode 21 is electrically neutralized by a plus charge (plus ion) in VUV irradiation atmosphere by the VUV lamp 20 in a state of possessing a high energy with an accelerated velocity (FIG. 2C). Accordingly, it is possible to suppress a charge damage and an excessive charge to the substrate S.

By making the gas cluster C including the charged gas cluster having a high energy accelerated by the accelerating electrode 21 collide with the substrate S, the particles P adhered on the surface of the substrate S can be removed with a high removal rate by a physical energy of the gas cluster C.

When the particles P are removed from the substrate S, the substrate S and the particles P are electrically charged into plus or minus due to the friction between the substrate S and the particles P. Thus, it is concerned that the particles P removed from the substrate S may be adhered again to the substrate S. However, in the present embodiment, the VUV from the VUV lamp 20 is irradiated also to the vicinity of the substrate S, thereby generating ions. The charged substrate S and particles P are neutralized by the ions. The neutralized particles P are discharged through the exhaust port 4 (FIG. 2D). Accordingly, readherence of the particles onto the substrate S can be very effectively suppressed.

Although there is possibility that the particles P may not be completely neutralized to leave some charges, even in that case, the particles are not readhered to the substrate S and the process chamber 1 and discharged along with an exhaust flow since the substrate S (the substrate mounting table 2) and the process chamber 1 are grounded and electrostatic effect on the particles is small.

Further, since the substrate S is grounded, even in a case where charged particles are generated from other elements than the substrate S, readherence of the particles can be very effectively suppressed.

As such, in accordance with the first embodiment, at least a part of the gas cluster irradiated toward the substrate S is charged by the VUV, and accelerated by the accelerating electrode 21 to collide with the substrate S. Accordingly, the gas cluster C has a high energy, and thus particles having a difficult shape to remove such as smaller particles and film-shaped particles (film-shaped impurities) and the like can be removed, thereby improving a particle removal rate. Further, the charged substrate and particles are neutralized by the VUV and the particles removed from the substrate are discharged along with an exhaust flow. Accordingly, readherence of the particles onto the substrate S can be suppressed. Furthermore, the charged gas cluster is electrically neutralized (charge-eliminated) by the VUV from the VUV lamp 20 before colliding with the substrate S. Accordingly, a charge damage (ion damage) of the substrate S can be suppressed.

Since the single VUV lamp 20 functions as a unit for electrically charging the gas cluster C, a unit for neutralizing the substrate S and the particles removed from the substrate S, and a unit for neutralizing the charged cluster, a configuration of the apparatus can be simplified.

### Second Embodiment

Next, the second embodiment will be described.

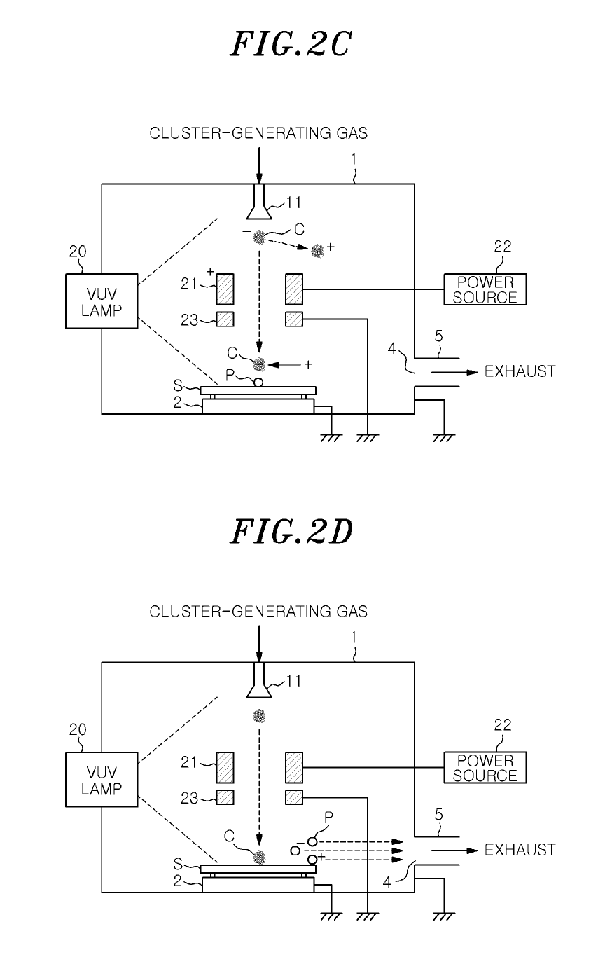

FIG. 3 is a cross-sectional view showing a substrate cleaning apparatus in accordance with the second embodiment of the present invention.

In the second embodiment, instead of the VUV lamp 20 of the first embodiment, two VUV lamps, i.e., a VUV lamp 20a for charging the gas cluster C and a VUV lamp 20b for neutralizing the substrate S, the particles removed from the substrate S, and the charged particles are provided. Moreover, a substrate arrangement region below the accelerating electrode 21 in the process chamber 1 is covered with a detachable cover 41 which is grounded. The other configurations are equal to those of the first embodiment, and thus redundant description thereof will be omitted.

In a substrate cleaning apparatus 101 of the second embodiment, at least a part of the gas cluster C jetted from the cluster nozzle 11 toward the substrate S is electrically charged by the VUV from the VUV lamp 20a, and the charged gas cluster collides with the substrate S in an accelerated state by the accelerating electrode 21. For this reason, the gas cluster C including the charged gas cluster possesses a high physical energy and thus the particles P adhered on the surface of the substrate S are removed at a high removal rate. Further, the charged substrate S and particles are neutralized by the VUV from the VUV lamp 20b, and the removed particles are discharged along with an exhaust flow. Accordingly, the readherence of the particles is suppressed. Furthermore, the charged gas cluster is electrically neutralized (charge-eliminated) before colliding with the substrate S by the VUV from the VUV lamp 20b, thereby suppressing a charge damage of the substrate S.

At this time, since the substrate arrangement region in the process chamber 1 is covered with the cover 41, the particles removed from the substrate S may be adhered to the cover 41. Therefore, after processing, the cover 41 is detached and cleaned and then installed again. By doing so, a cleaning process having a high cleanliness can be continuously performed.

### Third Embodiment

Next, the third embodiment will be described.

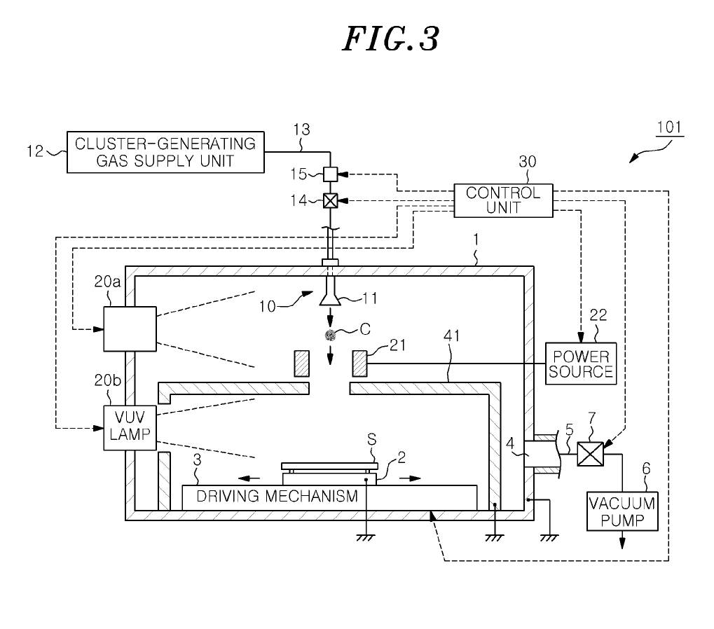

FIG. 4 is a cross-sectional view showing a substrate cleaning apparatus in accordance with the third embodiment of the present invention.

In a substrate cleaning apparatus 102 of the third embodiment, instead of the VUV lamp 20a serving as a unit for electrically charging the gas cluster C of the second embodiment, an ionization source 42 is provided at the outside of the process chamber 1. An ion component generated by the ionization source 42 is introduced into a gas cluster passing region in the process chamber 1. Moreover, the ground electrode 23 that is the same as that of the first embodiment is provided. The other configurations are equal to those of the second embodiment, and thus redundant description thereof will be omitted.

The ionization source 42 includes a container 43, an ionization gas introduction unit 44 for introducing an ionization gas such as Ar gas into the container 43, and a plasma source 45 provided in the container 43. Ions and electrons in a plasma generated by the plasma source 45 in the container 43 are introduced through a plasma introduction line 46 into a gas cluster passing region partitioned by a partition member 47 in the process chamber 1. Then, at least a part of the gas cluster C irradiated from the cluster nozzle 11 toward the substrate S is ionized to become a charged gas cluster. The charged gas cluster is accelerated by the accelerating electrode 21 and the gas cluster C including the accelerated charged gas cluster collides with the substrate S. Therefore, by a physical energy of that time, the particles P adhered to the surface of the substrate S can be removed at a high removal rate. Further, the charged substrate S and the removed particles are neutralized by the VUV from the VUV lamp 20b, and the removed particles are discharged along with an exhaust flow. Accordingly, readherence of the particles onto the substrate S can be suppressed. Furthermore, the charged gas cluster is electrically neutralized (charge-eliminated) before colliding with the substrate S by the VUV from the VUV lamp 20b, thereby suppressing a charge damage of the substrate S.

At this time, by introducing a reactive gas into the gas cluster passing region partitioned by the partition member 47 and irradiating the reactive gas together with the ionized gas cluster C to the substrate S, a cleaning process by the gas cluster and a cleaning process by the reactive gas can be performed together.

### Fourth Embodiment

Next, the fourth embodiment will be described.

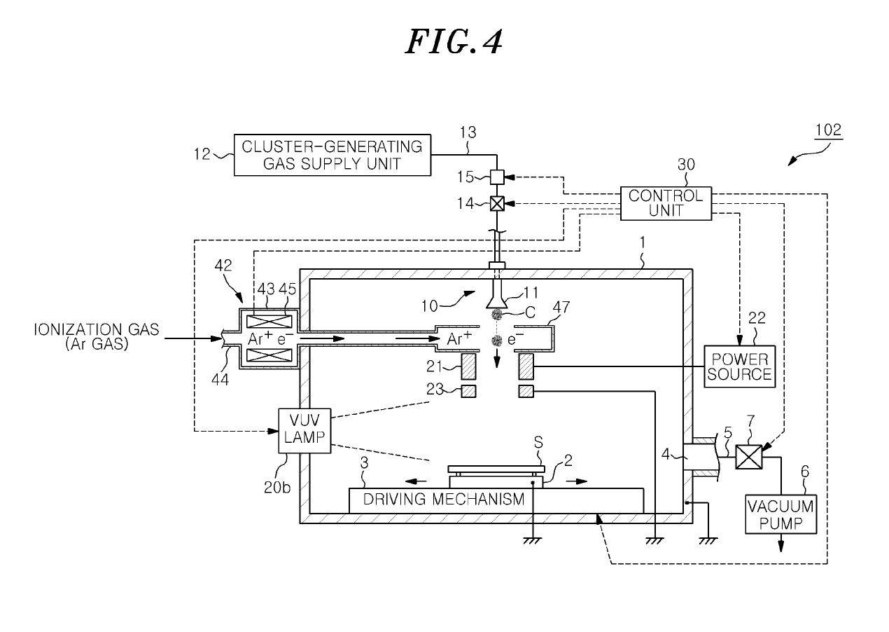

FIG. 5 is a cross-sectional view showing a substrate cleaning apparatus in accordance with the fourth embodiment of the present invention.

In a substrate cleaning apparatus 103 of the fourth embodiment, unlike the first to third embodiments, a charged gas cluster is generated without using a unit for electrically charging a gas cluster such as the VUV lamp. Specifically, instead of the gas cluster irradiation mechanism 10 used in the first to third embodiments, a gas cluster irradiation mechanism 50 capable of supplying a cluster-generating gas and He gas is used to jet the charged gas cluster from a cluster nozzle. The He gas, as will be described later, functions as a gas for electrically charging the gas cluster.

Specifically, the gas cluster irradiation mechanism 50 of the fourth embodiment includes: a cluster nozzle 51 provided at the upper portion of the process chamber 1 so as to face the substrate mounting table 2; a cluster-generating gas supply unit 52 provided at the outside of the process chamber 1 to supply a gas for generating a cluster to the cluster nozzle 51; a He gas supply unit 53 for supplying He gas; a cluster-generating gas supply line 54 connected to the cluster-generating gas supply unit 52; a He gas supply line 55 connected to the He gas supply unit 53; and a mixed gas supply line 56 which is formed by joining the cluster-generating gas supply line 54 and the He gas supply line 55, the cluster-generating gas and the He gas being guided to the cluster nozzle 51 through the mixed gas supply line 56. An opening/closing valve 57 and a flow rate controller 58 are provided at the cluster-generating gas supply line 54, and an opening/closing valve 59 and a flow rate controller 60 are provided at the He gas supply line 55. The cluster nozzle 51, as in the first to third embodiments, has a substantially conical shape that gradually widens toward the leading end, but the shape is not limited thereto.

Although not shown, a pressure increasing device (gas booster) for increasing a pressure of a mixed gas is provided at the mixed gas supply line 56. By the pressure increasing device, a supply pressure increases to a high pressure of 0.1 to 5 MPa. Also, although not shown, a pressure gauge is provided at the cluster-generating gas supply line 54 and the He gas supply line 55. The supply pressure is controlled based on a pressure value measured by the pressure gauge.

In the fourth embodiment, there is no VUV lamp serving as a unit for electrically charging the gas cluster, but only the VUV lamp 20b serving as a charge-eliminating unit, which is the same as that of the second embodiment, is used, and the gas cluster irradiation mechanism 50 is used instead of the gas cluster irradiation mechanism 10. The other configurations are equal to those in the first embodiment, and thus redundant description thereof will be omitted.

In the fourth embodiment, first, a gate valve is opened to load the substrate S through a loading/unloading port and the substrate S is mounted on the substrate mounting table 2. The interior of the process chamber 1 is vacuum-exhausted by the vacuum pump 6 to be kept at a vacuum state of a predetermined pressure. The pressure of the He gas and the cluster-generating gas such as CO₂ gas is, if necessary, increased by the pressure increasing device (gas booster) at a predetermined flow rate, and the He gas and the cluster-generating gas are jetted at a supply pressure ranging from 0.1 to 5 MPa from the cluster nozzle 51 of the gas cluster irradiation mechanism 50. Then, the cluster-generating gas is clusterized by adiabatic expansion, but the He gas is difficult to be clusterized so that it is jetted from the cluster nozzle 51 in almost a gas state.

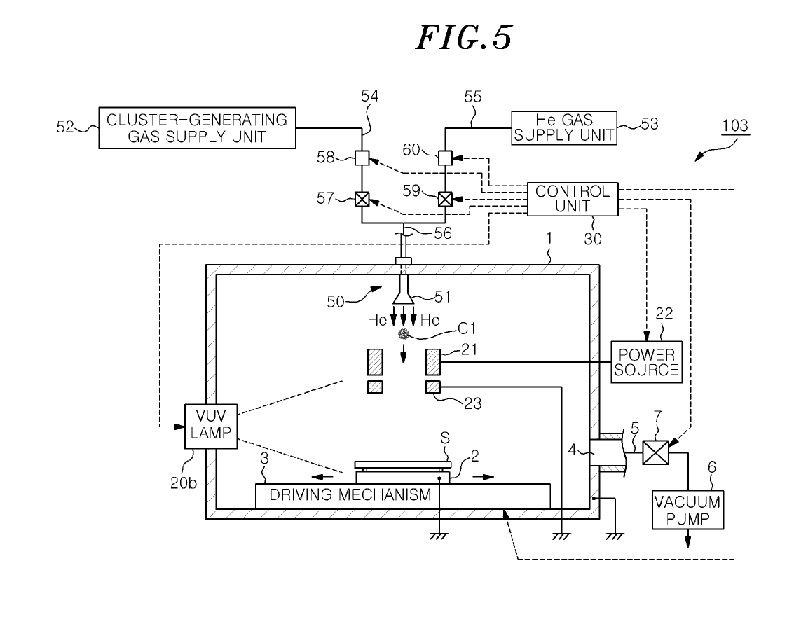

A jet velocity from the cluster nozzle 11 is faster in the He gas that is not clusterized than in the gas cluster. Accordingly, the He gas pushes the gas cluster to increase a velocity of the gas cluster. Practically, CO₂ gas serving as the cluster-generating gas and He gas were mixed and jetted from the cluster nozzle, and at this time, a velocity of a gas cluster was experimentally calculated. The calculation result is shown in FIG. 6. FIG. 6 is a view showing a relationship between a mixing ratio of He gas and a velocity of a gas cluster. From this, it is found that the velocity of the gas cluster increases as the mixing ratio of the He gas increases.

As such, when the velocity of the gas cluster increases, a friction is generated between the gas cluster and the inner wall of the cluster nozzle 51, and the gas cluster C1 including an electrically charged gas cluster is generated. The generated gas cluster C1 including the electrically charged gas cluster is irradiated toward the substrate S. At this time, as the velocity of the gas cluster increases, the amount of the electrically charged gas cluster increases. An electric charge is generated also by a friction between the gas cluster and the He gas.

A ratio of the He gas flow rate to the cluster-generating gas flow rate is preferable to be within a range from 10% to 99%. A supply pressure from the cluster nozzle is preferable to be between 0.1 MPa and 5 MPa. A pressure in the process chamber 1 is preferable to be 300 Pa or less.

Among the charged gas cluster formed as described above, one having opposite polarity to the accelerating electrode 21 is attracted and collides with the substrate S in an accelerated state. Accordingly, the gas cluster C1 including the charged gas cluster possesses a high physical energy, and thus the gas cluster C1 collides with the substrate S in a state having an increased cleaning power by the physical energy. Consequently, the particles P adhered on the surface of the substrate S can be removed at a high removal rate by the physical energy of the gas cluster C1 including the charged gas cluster.

The charged gas cluster having a high energy accelerated by the accelerating electrode 21 is electrically neutralized by ions in the VUV irradiation atmosphere by the VUV lamp 20b in a state of possessing the high energy with the accelerated velocity. Accordingly, it is possible to suppress a charge damage and an excessive charge to the substrate S. Further, there is a concern that the substrate S and the removed particles are electrically charged, due to the friction generated when the particles are removed from the substrate S, and that the removed particles are adhered again to the substrate S. However, the substrate S and the removed particles are neutralized by ions generated at the vicinity of the substrate S due to the VUV irradiation from the VUV lamp 20b, and the neutralized particles P are discharged through the exhaust port 4 along with an exhaust flow. Accordingly, readherence of the particles onto the substrate S can be very effectively suppressed.

In accordance with the fourth embodiment, the gas cluster C1 including the charged gas cluster is jetted from the cluster nozzle 51 and the charged gas cluster is accelerated by the accelerating electrode 21 and collides with the substrate S. Accordingly, the gas cluster C1 has a high energy, and thus particles having even a difficult shape to remove can be removed, thereby improving a particle removal rate. Further, the charged substrate and particles are neutralized by the VUV and the particles removed from the substrate S are discharged along with an exhaust flow. Accordingly, readherence of the particles onto the substrate S can be suppressed. Furthermore, the charged gas cluster is electrically neutralized (charge-eliminated) before colliding with the substrate S by the VUV from the VUV lamp 20b. Accordingly, a charge damage of the substrate S can be suppressed.

The charged gas cluster is generated by a simple method, e.g., by mixing the He gas with the cluster-generating gas such as CO₂ and jetting the mixed gas from the cluster nozzle 51. Therefore, a charging unit for electrically charging the gas cluster is unnecessary so that a configuration of the device can be simplified.

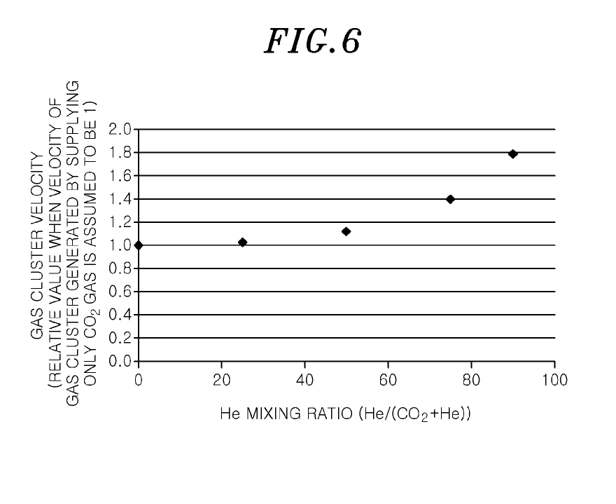

Next, a test that verifies the generation of the charged gas cluster by the fourth embodiment will be described. FIG. 7 is a schematic view showing a measurement system used in this test. A gas cluster irradiation mechanism 200 includes a CO₂ gas cylinder 201 and a He gas cylinder 202. The gas cluster irradiation mechanism 200 mixes CO₂ gas and He gas respectively supplied from the cylinders 201 and 202, and increases a pressure of the mixed gas by a gas booster 203. The mixed gas is jetted from a cluster nozzle 204 into a first process chamber 207 at a predetermined supply pressure to generate a gas cluster. The reference numeral 205 denotes a mass flow controller, and the reference numeral 206 denotes a pressure gauge. The interior of the first process chamber 207 becomes a vacuum atmosphere by a vacuum pump 208. The gas cluster jetted from the cluster nozzle 204 goes straight and passes through a skimmer cone 209 to reach a second process chamber 210. The interior of the second process chamber 210 becomes a vacuum atmosphere by a vacuum pump 211. At the second process chamber 210, a faraday cup 213 is provided at a position at which the gas cluster having straightly passed through the interior of the second process chamber 210 arrives. An amperemeter 214 is connected to the faraday cup 213. Further, an openable shutter 212 for blocking a path of the gas cluster toward the faraday cup 213 is provided in the second process chamber 210.

By using the measurement system, in a case of supplying only CO₂ gas, a case of supplying CO₂ gas mixed with He gas (CO₂:He=1:1 and CO₂:He=1:9), and a case of supplying only He gas, ion current was obtained while changing a supply pressure. The ion current was calculated as below.

Ion current=(a current value in a closed state of the shutter)−(a current value in an open state of the shutter)

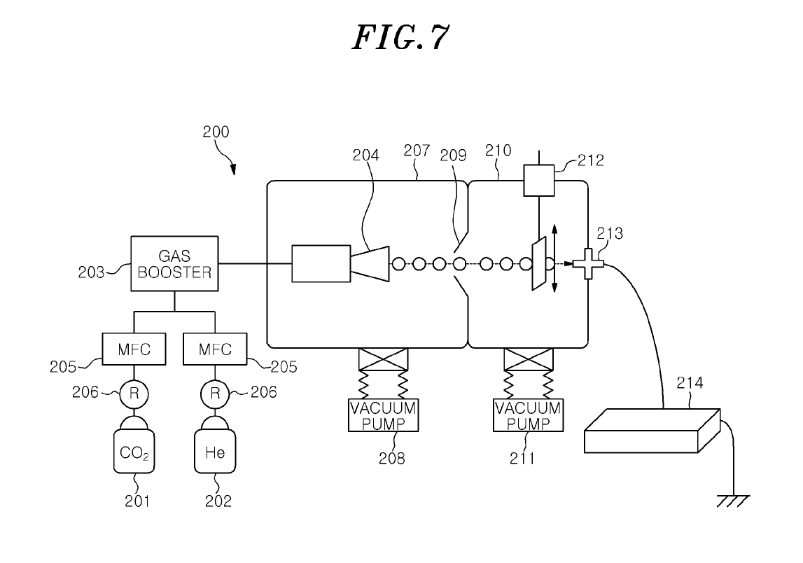

The result is shown in FIG. 8. As shown in FIG. 8, it is found that in the case of supplying only He gas, the ion current does not increase even when the gas supply pressure increases, and in the case of supplying only CO₂ gas, the ion current slightly increases as the gas supply pressure increases. It is also found that in the case of supplying CO₂ gas mixed with He gas, the ion current greatly increases as the gas supply pressure increases, and the increasing amount becomes greater as the proportion of He increases. Consequently, it is found that the gas cluster can be effectively electrically charged by the mixed gas of CO₂ gas and He gas.

### Fifth Embodiment

Next, the fifth embodiment will be described.

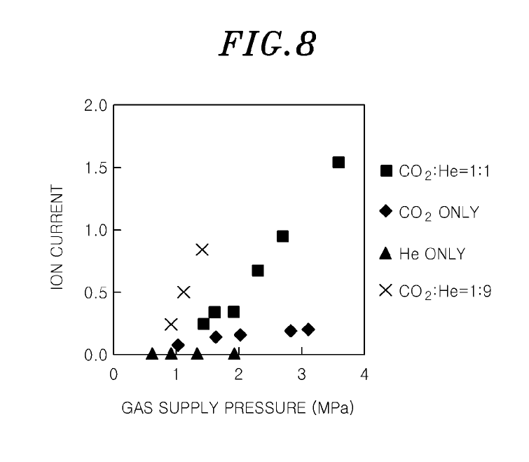

FIG. 9 is a cross-sectional view showing a substrate cleaning apparatus in accordance with the fifth embodiment of the present invention.

In a substrate cleaning apparatus 104 of the fifth embodiment, same as in the fourth embodiment, the charged gas cluster is formed by mixing the cluster-generating gas with a gas for electrically charging the gas cluster. However, the substrate cleaning apparatus 104 is different from that of the fourth embodiment in that hydrogen (H₂) gas is used as the gas for electrically charging the gas cluster.

In FIG. 9, instead of the He gas supply unit 53 and the He gas supply line 55 of the device shown in FIG. 5, a H₂ gas supply unit 53′ and a H₂ gas supply line 55′ are provided. The other configurations are equal to those of the device shown in FIG. 5, and thus redundant description thereof will be omitted.

In the fifth embodiment, first, a gate valve is opened to load the substrate S through a loading/unloading port and the substrate S is mounted on the substrate mounting table 2. The interior of the process chamber 1 is vacuum-exhausted by the vacuum pump 6 to be kept at a vacuum state of a predetermined pressure. The pressure of the H₂ gas and the cluster-generating gas such as CO₂ gas is, if necessary, increased by the pressure increasing device (gas booster) at a predetermined flow rate, and the H₂ gas and the cluster-generating gas are jetted at a supply pressure ranging from 0.1 to 5 MPa from the cluster nozzle 51 of the gas cluster irradiation mechanism 50. The cluster-generating gas is clusterized by adiabatic expansion, but the H₂ gas is, like the He gas, difficult to be clusterized so that it is jetted from the cluster nozzle 51 in almost a gas state.

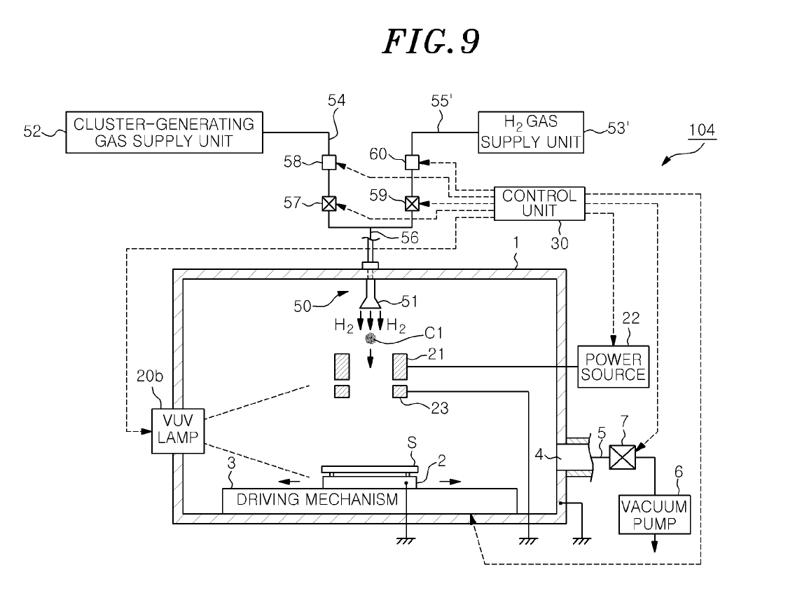

A jet velocity from the cluster nozzle 11 is faster in the H₂ gas that is not clusterized than in the gas cluster. Accordingly, the H₂ gas pushes the gas cluster to increase a velocity of the gas cluster. The velocity of the gas cluster when CO₂ gas serving as the cluster-generating gas are mixed with H₂ gas and jetted from a cluster nozzle is calculated based on a primary theoretical formula of a gas velocity in a model shown in FIG. 10. In FIG. 10, P₀ is an introducing gas pressure, T₀ is an introducing gas temperature, ρ₀ is an gas density, and Pₛ is a vacuum level of a generation part. In this case, a gas velocity v is expressed by the following Equation (1).

$$v = {\{ \frac{2 γ}{γ - 1} \frac{{k}_{B} {T}_{0}}{m} {( 1 - \frac{{P}_{s}}{{P}_{0}} )}^{( γ - 1 ) \text{/} γ} \}}^{1 \text{/} 2} , \qquad ( 1 )$$

where k_{B} is Boltzmann constant, γ is a ratio of specific heat of the introducing gas, and m is a mass of an introducing gas molecule.

Since a value of 1−(Pₛ/P₀) is almost 1 in a cluster generating pressure in the above Equation (1), the velocity of the gas cluster is represented by the following Equation (2).

$$v = \sqrt{\frac{2 γ}{γ - 1} \frac{{k}_{B} {T}_{0}}{m}} \qquad ( 2 )$$

As for a gas for electrically charging the gas cluster, with respect to a case of using He gas as in the fourth embodiment and a case of using H₂ gas as in the fifth embodiment, the velocity v of the gas cluster is calculated by using the above Equation (2) when a ratio between He gas and CO₂ gas serving as the cluster-generating gas, and a ratio between H₂ gas and CO₂ gas serving as the cluster-generating gas is 1:1. If the velocity of the gas cluster in the case of using He gas is assumed to be 1, the velocity of the gas cluster in the case of using H₂ gas is about 1.2, and a velocity ratio is about 1.2 times.

That is, it is obtained by calculation that by using H₂ gas as a gas for electrically charging the gas cluster, the velocity of the gas cluster becomes bigger about 10 to 20%, compared to the case of using He gas of the fourth embodiment.

Further, it is found by calculation through a hermohydrodynamic simulation that a gas temperature near a nozzle exit of the He or H₂ gas is −200° C. or less, and after adiabatic expansion, becomes equal to or less than −78.5° C. (194.5 K) that is a boiling point of CO₂. From this, it is seen that the case where H₂ gas is mixed with the cluster-generating gas also satisfies the condition for generating a cluster, as in the case where He gas is mixed with the cluster-generating gas.

As described above, the gas cluster can be generated by mixing H₂ gas with the cluster-generating gas. As in the fourth embodiment, the gas cluster C1 including the charged gas cluster is jetted from the cluster nozzle 51 and the charged gas cluster is accelerated by the accelerating electrode 21 and collides with the substrate S. Accordingly, the gas cluster C1 has a high energy, and thus particles having even a difficult shape to remove can be removed, thereby improving a particle removal rate. Further, the charged substrate and particles are neutralized by the VUV and the particles removed from the substrate S are discharged along with an exhaust flow. Accordingly, readherence of the particles onto the substrate S can be suppressed. Furthermore, the charged gas cluster is electrically neutralized (charge-eliminated) before colliding with the substrate S by the VUV from the VUV lamp 20b. Accordingly, a charge damage of the substrate S can be suppressed.

As in the fourth embodiment, since the charged gas cluster can be generated by a simple method, a charging unit for electrically charging the gas cluster is unnecessary so that a configuration of the device can be simplified. Further, by using H₂ gas as a gas for electrically charging the gas cluster, the velocity of the gas cluster becomes bigger about 10 to 20%, compared to the case of using He gas of the fourth embodiment. Therefore, the amount of the electrically charged gas cluster increases so that the cleaning effect is improved.

### Sixth Embodiment

Next, the sixth embodiment will be described.

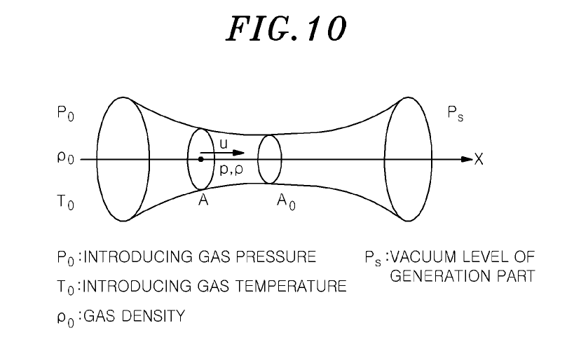

FIG. 11 is a cross-sectional view showing a substrate cleaning apparatus in accordance with the sixth embodiment of the present invention.

In a substrate cleaning apparatus 105 of the sixth embodiment, same as in the fourth and fifth embodiments, the charged gas cluster is generated without using a unit for electrically charging the gas cluster such as the VUV lamp and the like. However, the method of generating the charged gas cluster is different from those in the fourth and fifth embodiments.

In the sixth embodiment, the charged gas cluster is jetted from a cluster nozzle by using a gas cluster irradiation mechanism 60 which supplies alcohol as the cluster-generating gas.

Specifically, the gas cluster irradiation mechanism 60 includes: a cluster nozzle 61 provided at the upper portion of the process chamber 1 so as to face the substrate mounting table 2; a cluster-generating gas supply unit 62 provided at the outside of the process chamber 1 so as to supply alcohol as a gas for generating a cluster to the cluster nozzle 61; and a cluster-generating gas supply line 63 connected to the cluster-generating gas supply unit 62. An opening/closing valve 64 and a flow rate controller 65 are provided at the cluster-generating gas supply line 63. The cluster nozzle 61 has a substantially conical shape that gradually widens toward the leading end, but the shape is not limited thereto.

Although not shown, when alcohol gas serving as the cluster-generating gas is supplied from the cluster-generating gas supply unit 62, a vapor pressure of alcohol is increased by increasing a temperature of an alcohol supply line. Accordingly, the supply pressure to the nozzle can be increased. Further, an inert gas supply line may be connected to the alcohol supply line, and an inert gas supply pressure may be adjusted to control the supply pressure of the nozzle. In a case where, like alcohol, a source material is liquid, the aforementioned temperature increasing mechanism may be provided since the liquefaction under a high pressure condition is concerned. Also, although not shown, a pressure gauge is provided at the cluster-generating gas supply line 63 and the supply pressure is controlled based on a pressure value measured by the pressure gauge.

In the sixth embodiment, as in the fourth embodiment, there is no VUV lamp serving as a unit for electrically charging the gas cluster, but only the VUV lamp 20b serving as a charge-eliminating unit, which is the same as that of the second embodiment, is used, and the gas cluster irradiation mechanism 60 is used instead of the gas cluster irradiation mechanism 10. The other configurations are equal to those in the first embodiment, and thus redundant description thereof will be omitted.

In the sixth embodiment, first, a gate valve is opened to load the substrate S through a loading/unloading port and the substrate S is mounted on the substrate mounting table 2. The interior of the process chamber 1 is vacuum-exhausted by the vacuum pump 6 to be kept at a vacuum state of a predetermined pressure. The pressure of the alcohol gas is, if necessary, increased by the temperature increasing mechanism or the pressure increasing device (gas booster) at a predetermined flow rate, and the alcohol gas is jetted at a predetermined supply pressure from the cluster nozzle 61 of the gas cluster irradiation mechanism 60. The alcohol gas is clusterized by adiabatic expansion, and jetted from the cluster nozzle 61.

The molecule of alcohol gas is a polar molecule so that a negative electric charge of the polar molecule may be arranged toward the outer side (toward space) on a cluster surface formed of the alcohol molecules unlike the nonpolar molecule of CO₂ gas. Therefore, the cluster is easily electrically charged. For this reason, merely by clusterizing the alcohol gas, the gas cluster C1 including the charged gas cluster is formed and irradiated toward the substrate S.

Methanol gas and ethanol gas may be very preferably used as the alcohol gas. A vapor pressure of the methanol gas or ethanol gas becomes 5 times at 50° C., 12 times at 70° C., and 50 times at 100° C. when assuming 20° C. to be a criterion. Relatively plentiful amounts of the methanol gas or ethanol gas are supplied by heating and bubbling them in a liquid state. Therefore, a large amount of the gas cluster C1 including the charged gas cluster can be supplied. Further, as in the fourth embodiment, a He gas supply source and a He gas supply line may be provided. In this case, the amount of the electrically charged gas cluster is increased by mixing He gas with the cluster-generating gas.

Also in the sixth embodiment, the gas cluster C1 including the charged gas cluster is jetted from the cluster nozzle 61 and the charged gas cluster is accelerated by the accelerating electrode 21 and collides with the substrate S. Accordingly, the gas cluster C1 has a high energy, and thus particles having even a difficult shape to remove can be removed, thereby improving a particle removal rate. Further, the charged substrate and particles are neutralized by the VUV and the particles removed from the substrate S are discharged along with an exhaust flow. Accordingly, readherence of the particles onto the substrate S can be suppressed. Furthermore, the charged gas cluster is electrically neutralized (charge-eliminated) before colliding with the substrate S by the VUV from the VUV lamp 20b. Accordingly, a charge damage of the substrate S can be suppressed.

The charged gas cluster is generated by a simple method of only jetting the alcohol gas. Therefore, a charging unit for electrically charging the gas cluster is unnecessary so that a configuration of the device can be simplified.

(Other Applications)

The present invention may be variously modified without being limited to the above embodiments. For example, in the above embodiments, the gas cluster is generated by adiabatic expansion of the cluster-generating gas, but the method is not limited thereto. Further, a method of generating the charged gas cluster is also not limited to the above embodiments.

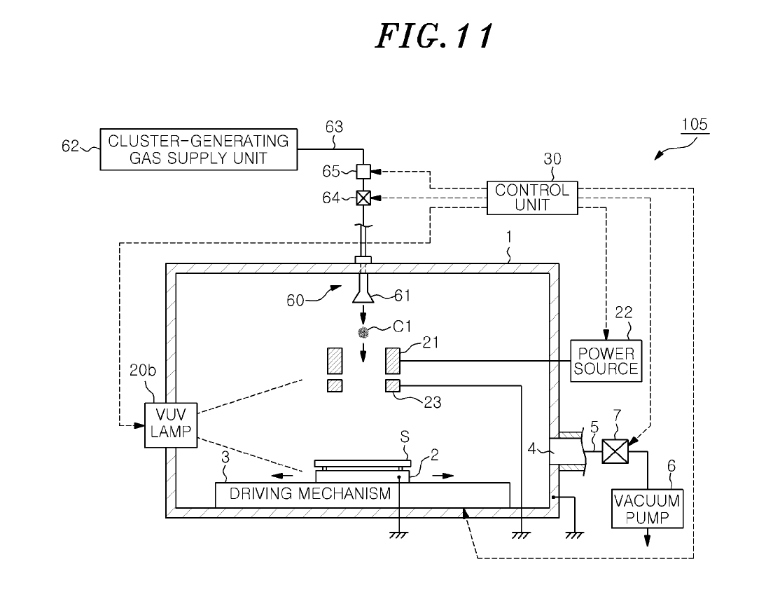

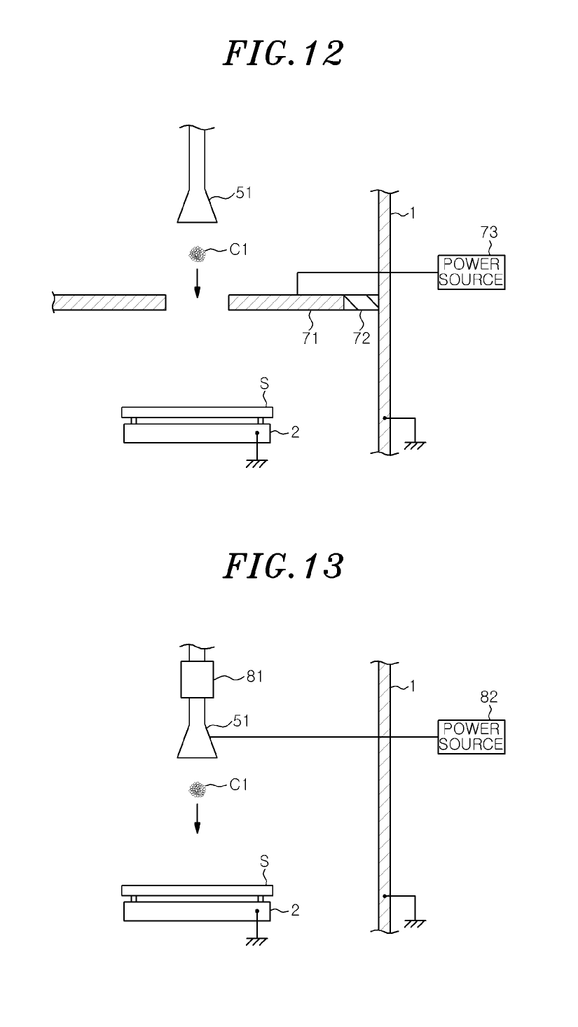

In the above embodiments, as a unit for accelerating the charged gas cluster, the accelerating electrode is provided between the cluster nozzle and the substrate. However, as in the fourth embodiment, in a case where the charged gas cluster is jetted from the cluster nozzle, the unit for accelerating the charged gas cluster is not limited thereto and may use an element shown in FIG. 12 or 13.

In an example shown in FIG. 12, a metal partition member 71 for partitioning the interior of the process chamber into a portion at which the gas cluster is generated and a portion at which the charged gas cluster is irradiated to the substrate is provided. In a state where the partition member 71 is insulated from the process chamber 1 by an insulating member 72, an electric charge is applied to the partition member 71 from a power source 73. By this configuration, a potential difference is generated between the partition member 71 and the cluster nozzle 51 that is a ground potential. Accordingly, the charged gas cluster C1 passing through the partition member 71 is accelerated.

Further, in FIG. 13, in a state where the cluster nozzle 51 is insulated from the process chamber 1 by an insulating member 81 such as an insulator, an electric charge is applied to the cluster nozzle 51 from a power source 82. By this configuration, a potential difference is generated between the cluster nozzle 51 and the substrate S that is a ground potential. Accordingly, the charged gas cluster C1 is accelerated.

In the above embodiment, an example that uses, as a charge-eliminating unit for neutralizing the substrate and the particles removed from the substrate, an electromagnetic wave irradiation unit such as the VUV lamp has been described. However, the charge-eliminating unit is not limited thereto.

The present invention may be executable by properly combining any of the above embodiments.

While the invention has been shown and described with respect to the embodiments, it will be understood by those skilled in the art that various changes and modifications may be made without departing from the scope of the invention as defined in the following claims.

What is claimed is:

1. A substrate cleaning method for cleaning a substrate, the substrate cleaning method comprising:
arranging the substrate in a process chamber and exhausting an interior of the process chamber to keep the interior of the process chamber at a vacuum state;
irradiating a gas cluster including an electrically charged gas cluster toward the substrate in the process chamber;
accelerating the electrically charged gas cluster before the electrically charged gas cluster reaches the substrate;
removing particles on the substrate by collision of the gas cluster including the accelerated electrically charged gas cluster with the substrate;
neutralizing the substrate and the particles which are electrically charged after said collision; and
discharging, from the process chamber, the removed and neutralized particles along with an exhaust flow.

2. The substrate cleaning method of claim 1, wherein the gas cluster is generated by adiabatic expansion of a cluster-generating gas jetted into the process chamber at a high pressure, and the electrically charged gas cluster is generated by electrically charging at least a part of the gas cluster.

3. The substrate cleaning method of claim 2, wherein the electrically charged gas cluster is generated by irradiating an electromagnetic wave to the gas cluster.

4. The substrate cleaning method of claim 3, wherein the electromagnetic wave is vacuum ultraviolet.

5. The substrate cleaning method of claim 2, wherein the substrate and the removed particles are neutralized by using an electromagnetic wave irradiated from an electromagnetic wave source which is the same as that used in generation of the electrically charged gas cluster.

6. The substrate cleaning method of claim 1, wherein the gas cluster is generated by adiabatic expansion of a cluster-generating gas jetted into the process chamber at a high pressure, and the electrically charged gas cluster is generated by supplying ions generated by an ionization source to the gas cluster.

7. The substrate cleaning method of claim 1, wherein the electrically charged gas cluster is generated by adiabatic expansion of a mixed gas jetted into the process chamber at a high pressure, the mixed gas including a cluster-generating gas and helium gas.

8. The substrate cleaning method of claim 7, wherein a ratio of a flow rate of the helium gas to a flow rate of the cluster-generating gas in the mixed gas is within a range from 10% to 99%.

9. The substrate cleaning method of claim 1, wherein the electrically charged gas cluster is generated by adiabatic expansion of a mixed gas jetted into the process chamber at a high pressure, the mixed gas including a cluster-generating gas and hydrogen gas.

10. The substrate cleaning method of claim 9, wherein a ratio of a flow rate of the hydrogen gas to a flow rate of the cluster-generating gas in the mixed gas is within a range from 10% to 99%.

11. The substrate cleaning method of claim 1, wherein the electrically charged gas cluster is generated by adiabatic expansion of alcohol gas jetted into the process chamber at a high pressure.

12. The substrate cleaning method of claim 1, wherein the electrically charged gas cluster is generated by adiabatic expansion of a mixed gas jetted into the process chamber at a high pressure, the mixed gas including alcohol gas and helium gas.

13. The substrate cleaning method of claim 7, wherein a jet pressure of the mixed gas is 0.1 MPa to 5 MPa.

14. The substrate cleaning method of claim 1, wherein said accelerating the electrically charged gas cluster is performed by attracting the electrically charged gas cluster by using a charge having an opposite polarity to the electrically charged gas cluster.

15. The substrate cleaning method of claim 1, further comprising:
neutralizing the electrically charged gas cluster before the electrically charged gas cluster reaches the substrate.

16. The substrate cleaning method of claim 1, wherein the substrate is held by a substrate holding unit, the substrate holding unit being grounded and the substrate being grounded through the substrate holding unit.

17. A substrate cleaning apparatus for cleaning a substrate by using a gas cluster, the substrate cleaning apparatus comprising:
a process chamber configured to accommodate the substrate therein;
an exhaust mechanism configured to exhaust an interior of the process chamber to be maintained in a vacuum state;
an irradiation unit configured to irradiate a gas cluster including an electrically charged gas cluster toward the substrate in the process chamber;
an acceleration unit configured to accelerate the electrically charged gas cluster before the electrically charged gas cluster reaches the substrate; and
a charge-eliminating unit configured to neutralize the substrate and particles on the substrate which are electrically charged after the particles on the substrate are removed by the gas cluster including the accelerated electrically charged gas cluster,
wherein the particles removed from the substrate and neutralized by the charge-eliminating unit are discharged along with an exhaust flow from the process chamber by the exhaust mechanism.

18. The substrate cleaning apparatus of claim 17, wherein the irradiation unit includes: a gas cluster-generating mechanism for generating the gas cluster by adiabatically expanding a cluster-generating gas jetted into the process chamber at a high pressure; and a charging unit for electrically charging at least a part of the generated gas cluster.

19. The substrate cleaning apparatus of claim 18, wherein the charging unit is configured to irradiate an electromagnetic wave to allow said at least a part of the generated gas cluster to become the electrically charged gas cluster.

20. The substrate cleaning apparatus of claim 19, wherein the charging unit is a vacuum ultraviolet lamp which irradiates vacuum ultraviolet rays.

21. The substrate cleaning apparatus of claim 19, wherein the charging unit is also configured to serve as the charge-eliminating unit by irradiating an electromagnetic wave.

22. The substrate cleaning apparatus of claim 17, wherein the irradiation unit includes: a gas cluster-generating mechanism for generating a gas cluster by adiabatically expanding a cluster-generating gas jetted into the process chamber at a high pressure; and an ionization source for supplying ions to at least a part of the generated gas cluster.

23. The substrate cleaning apparatus of claim 17, wherein the irradiation unit is configured to allow at least a part of the gas cluster to become the electrically charged gas cluster by adiabatically expanding a mixed gas jetted into the process chamber at a high pressure, the mixed gas including a cluster-generating gas and helium gas.

24. The substrate cleaning apparatus of claim 23, wherein a ratio of a flow rate of the helium gas to a flow rate of the cluster-generating gas in the mixed gas is within a range from 10% to 99%.

25. The substrate cleaning apparatus of claim 17, wherein the irradiation unit is configured to allow at least a part of the gas cluster to become the electrically charged gas cluster by adiabatically expanding a mixed gas jetted into the process chamber at a high pressure, the mixed gas including a cluster-generating gas and hydrogen gas.

26. The substrate cleaning apparatus of claim 25, wherein a ratio of a flow rate of the hydrogen gas to a flow rate of the cluster-generating gas in the mixed gas is within a range from 10% to 99%.

27. The substrate cleaning apparatus of claim 17, wherein the irradiation unit is configured to allow at least a part of the gas cluster to become the electrically charged gas cluster by adiabatically expanding alcohol gas jetted into the process chamber at a high pressure.

28. The substrate cleaning apparatus of claim 27, wherein the irradiation unit jets a mixed gas of the alcohol gas and helium gas into the process chamber and adiabatically expands the mixed gas.

29. The substrate cleaning apparatus of claim 23, wherein a jet pressure of the mixed gas is 0.1 MPa to 5 MPa.

30. The substrate cleaning apparatus of claim 17, wherein the acceleration unit is configured to attract the electrically charged gas cluster by using a charge having an opposite polarity to the electrically charged gas cluster, until the electrically charged gas cluster reaches the substrate.

31. The substrate cleaning apparatus of claim 17, further comprising:
a detachable cover configured to cover a substrate arrangement region in the process chamber.

32. The substrate cleaning apparatus of claim 17, wherein the charge-eliminating unit is configured to neutralize the electrically charged gas cluster before the electrically charged gas cluster reaches the substrate.

33. The substrate cleaning apparatus of claim 17, further comprising a substrate holding unit which is grounded, wherein the substrate is held by the substrate holding unit and the substrate is grounded through the substrate holding unit.
